(19) United States
(12) Patent Application Publication
(10) Pub. No.: US 2025/0250369 A1
(43) Pub. Date: Aug. 7, 2025

(54) ETHYLENE POLYMERISATION CATALYST SYSTEM

(71) Applicant: SABIC GLOBAL TECHNOLOGIES B.V., Bergen op Zoom (NL)

(72) Inventors: Lidong Li, Riyadh (SA); Yahya Banat, Riyadh (SA); Nasser Abdullah Alsaif, Riyadh (SA)

(21) Appl. No.: 18/856,201

(22) PCT Filed: Apr. 7, 2023
(86) PCT No.: PCT/EP2023/059329

§ 371 Date: Oct. 11, 2024

(30) Foreign Application Priority Data
Apr. 14, 2022 (EP) 22168606.6

(51) Int. Cl. C08F 10/02

(52) U.S. Cl. CPC C08F 10/02; C08F 2420/10

(57) ABSTRACT

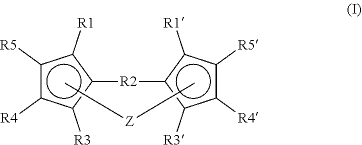

Catalyst system for polymerisation of ethylene comprising a porous support material, wherein the support material comprises, preferably on its surface and in its pores: (i) a quantity of a compound (a) of formula (I) wherein: Z is a moiety selected from M-X₂, wherein X is selected from the group of halogens, alkyls, aryls and aralkyls and wherein M is selected from Zr, Hf and Ti; • R2 is a silane bridging moiety; • each R1, R1′, R3, R3′, R4, R4′, R5 and R5′ are hydrogen or a hydrocarbon moiety comprising 1-20 carbon atoms; and (ii) a quantity of methylaluminoxane; wherein the catalyst system comprises: • ≥2.5*10″5 mol/g, preferably ≥2.5*10″5 and ≤10.0*10″5 mol/g, more preferably ≥2.7*10″5 and ≥10.0*10″5 mol/g, of M, with regard to the total weight of the catalyst system, and, • ≥5.0 wt %, preferably ≥5.0 and ≤20.0 wt %, of aluminium, with regard to the total weight of the catalyst system. Such catalyst system allows for the production of polyethylenes at high productivity and activity.

The present invention relates to a catalyst system for the polymerisation of ethylene. The invention further relates to a process for preparation of such catalyst system. The invention also relates to a process for polymerisation of ethylene using such catalyst system.

Polymers produced from ethylene are well known to be of the most versatile polymeric materials available. Capable of being produced in an economic way at high and consistent product quality, and, by variation of amongst others polymerisation conditions and raw material formulations, in a wide array of grades each satisfying certain application needs, suitable for use in the production of a multitude of articles.

Such polymers produced from ethylene, also referred to as polyethylenes, may be homopolymers of ethylene, or may in certain circumstances be produced using further monomers next to ethylene as part of the raw material formulation used in the polymerisation reactions. Typical further monomers, referred to as comonomers, may include α-olefins, particularly α-olefins having 3 to 10 carbon atoms. Such α-olefin comprising 3 to 10 carbon atoms may for example be selected from propylene, 1-butene, 1-pentene, 1-hexene, 1-octene, and 4-methyl-1-pentene. Particularly appropriate compounds to be used as comonomer are 1-butene, 1-hexene and 1-octene.

In the ethylene-α-olefin copolymer according to the invention, one single comonomer may be used, or a combination of multiple comonomers may be used. It is preferred that one single comonomer is used. Accordingly, it is preferred that the ethylene-α-olefin copolymer according to the invention comprises moieties derived from ethylene and moieties derived from a single comonomer.

A particular type of applications in which polyethylenes find abundant use is in films and laminates of films. There exist various techniques for manufacturing of films out of polyethylenes, including cast film production, blown film production, and oriented film production. In each of these techniques, the polyethylene materials are first brought to molten conditions, and subsequently the molten material is converted into a film-shape and solidified, typically by forcing the molten material through a die having such dimensions to allow the desired film to be obtained from the process, and subsequent cooling down to below melting point to solidify the film.

In order to adequately manufacture such film, and to ensure that the film complies with the required properties, stringent conditions are set for the nature of the polyethylene material. Current trends in applications of polyethylene films, such as a combination of increase in production speed, down-gauging of the films to reduce the quantity of materials used, and increased mechanical property demands, act as driver for the polymer industry to continue to develop polyethylene materials that meet these criteria.

A particular aspect of ethylene polymerisation that has its reflection on the nature of the polymer that is produced, and the efficiency of the polymerisation process, is the catalytic system that is used in the polymerisation.

A particular family of catalysts that may be suitable for the production of polyethylenes via catalytic polymerisation processes are the so-called single-site catalysts, a well-known group of species of which are the catalysts referred to as metallocene catalysts. Whilst such catalysts are broadly applied in the manufacture of polyethylene products, there continue to be a desire to develop catalyst systems that allow for the production of polyethylenes having desired polymer properties such as a desired density, molecular weight distribution (M_{w}/Mₙ), and a high molecular weight M_{w}, whilst polymerisation may be performed at high productivity of polymer per quantity of supplied catalyst, at high monomer conversion rate, and where the occurrence of reactor fouling due to excessive heat generation is prevented.

This is now provided according to the present invention by a catalyst system for polymerisation of ethylene comprising a porous support material, wherein the support material comprises, preferably on its surface and in its pores:
(i) a quantity of a compound (a) of formula (I)

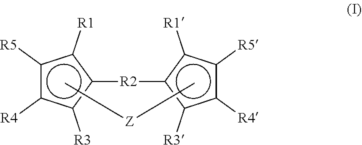

wherein:
   Z is a moiety selected from M-X₂, wherein X is selected from the group of halogens, alkyls, aryls and aralkyls and wherein M is selected from Zr, Hf and Ti;
   R2 is a silane bridging moiety;
   each R1, R1′, R3, R3′, R4, R4′, R5 and R5′ are hydrogen or a hydrocarbon moiety comprising 1-20 carbon atoms; and
(ii) a quantity of methylaluminoxane;
wherein the catalyst system comprises:
   ≥2.5*10⁻⁵ mol/g, preferably ≥2.5*10⁻⁵ and ≤10.0*10⁻⁵ mol/g, more preferably ≥2.7*10⁻⁵ and ≤10.0*105 mol/g, of M, with regard to the total weight of the catalyst system, and
   ≥5.0 wt %, preferably ≥5.0 and ≤20.0 wt %, of aluminium, with regard to the total weight of the catalyst system.

The silane bridging moiety may for example be a moiety of formula:

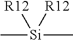

wherein each moiety R12 is a is a hydrocarbyl group, preferably a C1-C4 alkyl group. For example, each R12 may be a moiety selected from methyl, ethyl, n-propyl, isopropyl, n-butyl, or isobutyl, preferably each R12 is a methyl moiety. The silane bridging moiety preferably is a dimethylsilane moiety.

The catalyst system may for example comprise preferably ≥5.0 and ≤10.0 wt % of aluminium, with regard to the total weight of the catalyst system.

The compound (a) may be a compound of the formula:

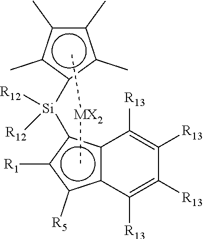

wherein each R13 is hydrogen or a hydrocarbon moiety comprising 1-20 carbon atoms.

Preferably, the compound (a) comprises a (2,3,4,5-tetramethyl-1-cyclopentadienyl) group that is bridged through a dihydrocarbyl-silyl bridge to a 1-indenyl group, which 1-indenyl group is substituted with one or more substituents. R12 preferably is a C1-C4 alkyl group, most preferably a methyl group.

In a preferred embodiment, R1 is selected from isopropyl, phenyl, 3,5-dialkyl-1-phenyl, preferably 3,5-dimethyl-1-phenyl, 3,5-diethyl-1-phenyl, 3,5-diisopropyl-1-phenyl or 3,5-ditertiairybutyl-1-phenyl. For example, R1 may be isopropyl or phenyl. For example, R1 may be isopropyl. For example, R1 may be phenyl.

The compound (a) preferably is a compound according to the formula:

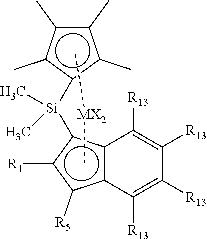

More preferably, the compound (a) is a compound according to the formula:

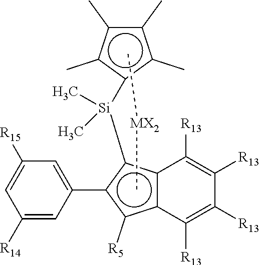

wherein R14 and R15 are selected from H and C1-C10 alkyl groups. Most preferably, R14 and R15 are chosen from H, methyl, ethyl, propyl, isopropyl or tertiary butyl groups. Most preferably, each R13 is H.

It is preferred that X is Cl.

The catalyst system may for example comprise a quantity of a complex (b) obtained by reacting a quantity of an aluminium compound of formula (II) with a quantity of an amine compound of formula (III) in a hydrocarbon solvent;

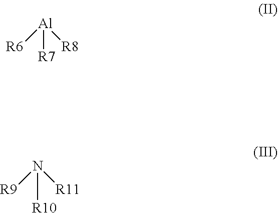

wherein R6 is hydrogen or a hydrocarbon moiety comprising 1 to 30 carbon atoms; each R7 and R8 are the same or different and are hydrocarbon moieties comprising 1 to 30 carbon atoms; R9 is hydrogen or a functional moiety comprising at least one active hydrogen; R10 is hydrogen or a hydrocarbon moiety comprising 1 to 30 carbon atoms; R11 is a hydrocarbon moiety comprising 1 to 30 carbon atoms. It is preferred that the complex (b) is a triisobutylaluminium/cyclohexylamine complex.

The porous support material may for example be selected from a cross-linked or functionalised polystyrene, a polyvinylchloride, a cross-linked polyethylene, a silica, an MgCl₂, a talc, and a zeolite, preferably wherein the support material has an average particle size of 1 to 120 μm, more preferably 20 to 80 μm, even more preferably 40 to 50 μm. Preferably, the porous support material is a silica. Preferably, the porous support material comprises ≤0.1 wt % of aluminium with regard to the weight of the porous support material, more preferably the porous support material is free from aluminium.

In the catalyst system according to the present invention, it is preferred that the molar ratio of the methylaluminoxane to the compound (a) is ≥50 and ≤500, preferably ≥100 and ≤ 300, more preferably ≥150 and $300.

In the catalyst system according to the present invention, it is preferred that the weight ratio of the methylaluminoxane to the support material is ≥0.1 and ≤0.8, preferably ≥0.2 and ≤ 0.6, more preferably ≥0.3 and ≤0.6.

In the catalyst system according to the present invention, it is preferred that the weight ratio of the compound (a) to the support material is ≥0.005 and ≤0.08, preferably ≥0.01 and ≤ 0.05, more preferably ≥0.01 and ≤0.03.

A preferred compound (a) that may be used in the catalyst system according to the invention may be selected from:
dichloro[[(1,2,3,3a,7a-η)-2-(1-methylethyl)-1H-inden-1-ylidene](dimethylsilylene)[(1,2,3,4,5-η)-2,3,4,5-tetramethyl-2,4-cyclopentadien-1-ylidene]]-zirconium;
dichloro[[(1,2,3,3a,7a-η)-2-phenyl-1H-inden-1-ylidene](dimethylsilylene)[(1,2,3,4,5-η)-2,3,4,5-tetramethyl-2,4-cyclopentadien-1-ylidene]]-zirconium;
dichloro[[(1,2,3,3a, 7a-η)-2-methyl-4-phenyl-1H-inden-1-ylidene](dimethylsilylene)[(1,2,3,4,5-η)-2,3,4,5-tetramethyl-2,4-cyclopentadien-1-ylidene]]-zirconium;
dichloro[[(1,2,3,3a,7a-η)-3-phenyl-1H-inden-1-ylidene](dimethylsilylene)[(1,2,3,4,5-η)-2,3,4,5-tetramethyl-2,4-cyclopentadien-1-ylidene]]-zirconium;
dichloro[[(1,2,3,3a,7a-η)-2-phenyl-3-methyl-1H-inden-1-ylidene](dimethylsilylene)[(1,2,3,4,5-η)-2,3,4,5-tetramethyl-2,4-cyclopentadien-1-ylidene]]-zirconium;
dichloro[[(1,2,3,3a,7a-η)-2-phenyl-1H-inden-1-ylidene](dimethylsilylene)[(1,2,3,3a,7a-η)-1H-inden-2-ylidene]]-zirconium;
dichloro[[(1,2,3,3a,7a-η)-2-(3,5-dimethylphenyl)-1H-inden-1-ylidene](dimethylsilylene)[(1,2,3,3a,7a-η)-1,3-dimethyl-1H-inden-2-ylidene]]-zirconium;
dichloro[[(1,2,3,3a,7a-η)-2-tertiarybutyl-1H-inden-1-ylidene](dimethylsilylene)[(1,2,3,3a,7a-η)-1,3-dimethyl-1H-inden-2-ylidene]]-zirconium;
dichloro[[(1,2,3,3a,7a-η)-1H-inden-2-ylidene](dimethylsilylene)[(1,2,3,4,5-η)-2,3,4,5-tetramethyl-2,4-cyclopentadien-1-ylidene]]-zirconium;
dichloro[[(1,2,3,3a,7a-η)-2-(1-methylethyl)-1H-inden-1-ylidene](dimethylsilylene)[(1,2,3,3a,7a-η)-1,3-dimethyl-1H-inden-2-ylidene]]-zirconium;
dichloro[[(1,2,3,3a, 7a-η)-2-phenyl-3-methyl-1H-inden-1-ylidene](dimethylsilylene)[(1,2,3,3a,7a-η)-1,3-dimethyl-1H-inden-2-ylidene]]-zirconium;
[[(1,2,3,3a, 7a-η)-2-(1-methylethyl)-1H-inden-1-ylidene](dimethylsilylene)[(1,2,3,4,5-η)-2,3,4,5-tetramethyl-2,4-cyclopentadien-1-ylidene]]-hafnium; and
dichloro[[(1,2,3,3a,7a-η)-2-phenyl-1H-inden-1-ylidene](dimethylsilylene)[(1,2,3,4,5-η)-2,3,4,5-tetramethyl-2,4-cyclopentadien-1-ylidene]]-hafnium.

Particularly preferable, the compound (a) is selected from
dichloro[[1,2,3,3a,7a-η)-2-(1-methylethyl)-1H-inden-1-ylidene](dimethylsilylene) [1,2,3,4,5-η)-2,3,4,5-tetramethyl-2,4-cyclopentadien-1-ylidene]]-zirconium;
dichloro[[(1,2,3,3a,7a-η)-2-phenyl-1H-inden-1-ylidene](dimethylsilylene)[(1,2,3,4,5-η)-2,3,4,5-tetramethyl-2,4-cyclopentadien-1-ylidene]]-zirconium;
dichloro[[(1,2,3,3a, 7a-η)-2-methyl-4-phenyl-1H-inden-1-ylidene](dimethylsilylene)[(1,2,3,4,5-η)-2,3,4,5-tetramethyl-2,4-cyclopentadien-1-ylidene]]-zirconium;
dichloro[[(1,2,3,3a,7a-η)-3-phenyl-1H-inden-1-ylidene](dimethylsilylene)[(1,2,3,4,5-η)-2,3,4,5-tetramethyl-2,4-cyclopentadien-1-ylidene]]-zirconium; and
dichloro[[(1,2,3,3a,7a-η)-2-phenyl-3-methyl-1H-inden-1-ylidene](dimethylsilylene)[(1,2,3,4,5-η)-2,3,4,5-tetramethyl-2,4-cyclopentadien-1-ylidene]]-zirconium.

In the compound (a), the moieties R4 and R5 may be fused to form a cyclic structure, and/or the moieties R4′ and R5′ may be fused to form a cyclic structure, and/or the moieties R3 and R4 may be fused to form a cyclic structure, and/or the moieties R3′ and R4′ may be fused to form a cyclic structure. Where such moieties are fused to form a cyclic structure, it is preferred that the formed cyclic structure together with the pentadienyl moiety forms an indenyl structure. Such indenyl structure may be substituted or unsubstituted.

An embodiment of the invention also relates to a process for preparation of a catalyst system according to the invention, wherein the process involves the steps in this order of:
(i) preparing a first mixture by subjecting a quantity of compound (a) together with a quantity of the methylaluminoxane as solution in a hydrocarbon solvent, preferably at a temperature of 20-80° C. for a period of 0.1-2.0 hrs;
(ii) preparing a second mixture by reacting a quantity of triisobutylaluminium with a quantity of cyclohexylamine in a hydrocarbon solvent;
(iii) providing a quantity of the support material into a reaction vessel;
(iv) providing a quantity of a hydrocarbon solvent into the reaction vessel;
(v) supplying the first mixture and the second mixture to the reaction vessel;
(vi) subjecting the contents of the reaction vessel to a temperature of >60° C. for a period of >3 hrs, preferably >3 hrs and <10 hrs, to obtain a catalyst system; and
(vii) removing the hydrocarbon solvent from the catalyst system.

It is preferred that the temperature in step (vi) is >90° C., more preferably >90° C. and <110° C.

The invention also relates to a process for polymerisation of ethylene, wherein the polymerisation is performed in the presence of a catalyst system according to the invention, or a catalyst system produced according to the process of the invention.

In a certain embodiment, the invention also relates to a polyethylene composition comprising the catalyst system of the invention, preferably wherein the polyethylene composition comprises a polyethylene and the catalyst system of the invention.

The invention will now be illustrated by the following non-limiting examples.

### Materials

The following materials were used in the experiments to demonstrate the invention. All materials were handled under protection of nitrogen atmosphere using either Schlenk techniques or nitrogen filled glovebox. As support, Sylopol® 955W silica (obtainable from W.R. Grace & Co.) was used. Methylaluminoxane (MAO) was used as a 10 wt % solution in toluene (obtainable from W.R. Grace & Co.). As compound (a), dimethylsilyl(2,3,4,5-tetramethylcyclopentadienyl)(2-isopropyl-inden-1-yl)zirconium dichloride, CAS Reg. Nr. 2247072-26-8 was used. Triisobutylaluminum (TIBAL) was purchased from Sigma-Aldrich. Toluene (HPLC grade, 99.9%) and cyclohexylamine (99.9%) were purchased from Sigma-Aldrich and purged by nitrogen gas before use. A mixture of TIBAL and cyclohexylamine in hexane (AXION® PA 4276, purchased from Lanxess) was used in the polymerisation experiments.

### Catalyst System Preparation

The support was pre-dehydrated at 600° C. for 4 hours. 2.5 g of the pre-dehydrated support was charged into a 100 ml two-neck Schlenk flask in a glovebox under nitrogen atmosphere, followed by addition of 15 ml of toluene. After shaking, a suspension was obtained. Given amounts of the compound (a), also referred to as the metallocene, was activated by mixing it with given amounts of MAO in toluene in a 25 ml vial at room temperature (23° C.) for 10 min in the glovebox. The amounts of compound (a) and MAO that were used in the examples are presented in the table below.

| | Example | | | | | |
|---|---|---|---|---|---|---|
| | A1 | A2 | A3 | A4 | B1 | B2 |
| Metallocene (g) | 0.020 | 0.030 | 0.042 | 0.080 | 0.022 | 0.034 |
| MAO solution | 5.9 | 6.0 | 6.0 | 6.1 | 9.9 | 10.0 |
| (ml) | | | | | | |

| | Example | | | | | |
|---|---|---|---|---|---|---|
| | B3 | B4 | C1 | C2 | C3 | C4 |
| Metallocene (g) | 0.047 | 0.090 | 0.024 | 0.036 | 0.050 | 0.096 |
| MAO solution | 10.0 | 10.2 | 12.3 | 12.4 | 12.4 | 12.6 |
| (ml) | | | | | | |

The activated metallocene was transferred into the suspension. 0.0064 g of TIBAL and 0.0032 g of cyclohexylamine were mixed in 10 ml of toluene in another 25 ml vial at room temperature (23° C.) for 10 min in the glovebox and then was transferred into the suspension. The final mixture was heated to 95° C. and maintained at that temperature for 5 hours. Subsequently, the product was dried at 75° C. under vacuum to obtain the catalyst system, which was isolated as free-flowing powder.

| | Example | | | | | |
|---|---|---|---|---|---|---|
| | A1 | A2 | A3 | A4 | B1 | B2 |
| Zr (wt %) | 0.12 | 0.18 | 0.249 | 0.473 | 0.12 | 0.18 |
| Zr (*10⁻⁵ mol/g catalyst) | 1.31 | 1.97 | 2.73 | 5.19 | 1.31 | 1.97 |
| Al (wt %) | 8.0 | 8.0 | 8.0 | 8.0 | 12.0 | 12.0 |
| Al (*10⁻² mol/g catalyst) | 0.30 | 0.30 | 0.30 | 0.30 | 0.44 | 0.44 |
| Molar ratio Al/Zr | 226 | 150 | 109 | 57 | 338 | 225 |
| | Example | | | | | |
| | B3 | B4 | C1 | C2 | C3 | C4 |
| Zr (wt %) | 0.249 | 0.473 | 0.12 | 0.18 | 0.249 | 0.473 |
| Zr (*10⁻⁵ mol/g catalyst) | 2.73 | 5.19 | 1.31 | 1.97 | 2.73 | 5.19 |
| Al (wt %) | 12.0 | 12.0 | 14.0 | 14.0 | 14.0 | 14.0 |
| Al (*10⁻² mol/g catalyst) | 0.44 | 0.44 | 0.52 | 0.52 | 0.52 | 0.52 |
| Molar ratio Al/Zr | 163 | 86 | 396 | 262 | 190 | 100 |

### Polymerisation Experiments: Ethylene Homopolymerisation

A 1.6 l stainless steel reactor vessel equipped with a helical stirrer and a heating/cooling control unit was heated to 110° C. at a nitrogen flow rate of 100 g/h for 2 hours. After that, the reactor was pressure purged with nitrogen, followed by a purge with ethylene. This purging cycle was repeated three times.

The reactor was then cooled to 88° C. under ethylene pressurised to 10 bar. After venting, 4 ml of AXION® PA 4276 was added via a cocatalyst injection pump. Nitrogen was introduced to maintain a nitrogen pressure of 8 bar. Ethylene was then introduced to the reactor under control of mass flow parameters to maintain an ethylene pressure in the reactor of 10 bar. Upon reaching a stable level of temperature and pressure, 80 mg of the catalyst system was injected via a catalyst injection pump and the reaction started. After 1 hour, the ethylene supply was discontinued and the reactor was cooled to 40° C. The reactor was opened after venting. The polyethylene product was collected to a sample tray and dried at ambient temperature under atmospheric pressure.

| | | Productivity | | | | |
|---|---|---|---|---|---|---|
| Experiment | Catalyst | (g PE/g cat) | BD | Mₙ | M_{w} | M_{w}/Mₙ |
| D1 | A1 | 297 | 0.238 | 90 | 270 | 3.00 |
| D2 | A2 | 312 | 0.267 | 85 | 257 | 3.01 |
| D3 | A3 | 349 | 0.260 | 86 | 243 | 2.84 |
| D4 | A4 | 393 | 0.270 | 78 | 236 | 3.01 |
| D5 | B1 | 316 | 0.297 | 81 | 243 | 2.99 |
| D6 | B2 | 358 | 0.327 | 72 | 224 | 3.11 |
| D7 | B3 | 520 | 0.331 | 67 | 206 | 3.05 |
| D8 | B4 | 651 | 0.315 | 66 | 216 | 3.26 |
| D9 | C1 | 329 | 0.324 | 75 | 221 | 2.94 |
| D10 | C2 | 424 | 0.351 | 68 | 214 | 3.16 |
| D11 | C3 | 533 | 0.348 | 67 | 203 | 3.04 |
| D12* | C4 | 683 | 0.330 | 82 | 253 | 3.08 |

### Wherein:

The productivity is the quantity of polyethylene (PE) that was obtained per quantity of catalyst supplied, in g PE/g catalyst;
BD is the bulk density, expressed in g/cm³, determined in accordance with ASTM D1895-17;
The weight-average molecular weight (M_{w}), and the number-average molecular weight (Mₙ) are expressed in kg/mol, and determined in accordance with ASTM D6474 (2012)
   *In the experiment D12, the quantity of catalyst system that was supplied was 40 mg, to prevent lump formation in the reactor and reactor overheating, caused by the high catalyst productivity.

The catalyst containing relatively low content of Al (D1) shows a high initial activity and a low peak activity, whereas the catalysts containing relatively high content of Al (D5 and D9) exhibit low initial activities and high peak activities and high overall activities, which is preferred for gas phase olefin polymerization processes.

### Polymerisation Experiments: Ethylene/1-Hexene Copolymerisation

A 1.6 l stainless steel reactor vessel equipped with a helical stirrer and a heating/cooling control unit was heated to 110° C. at a nitrogen flow rate of 100 g/h for 2 hours. After that, the reactor was pressure purged with nitrogen, followed by a purge with ethylene. This purging cycle was repeated three times.

The reactor was then cooled to 88° C. under ethylene pressurised to 10 bar. After venting, 4 ml of AXION® PA 4276 was added via a cocatalyst injection pump. Nitrogen was introduced to maintain a nitrogen pressure of 8 bar. Ethylene and 1-hexene with given molar ratio as in the table below were then introduced to the reactor under control of mass flow parameters to maintain the total pressure of ethylene and 1-hexene in the reactor of 10 bar. Upon reaching a stable level of temperature and pressure, 80 mg of the catalyst system was injected via a catalyst injection pump and the reaction started. After 1 hour, the ethylene and 1-hexene supplies were discontinued and the reactor was cooled to 40° C. The reactor was opened after venting. The polyethylene product was collected to a sample tray and dried at ambient temperature under atmospheric pressure.

| Experiment | Catalyst | C6/C2 | Productivity | BD | Density | Mn | Mw | Mw/Mn |
|---|---|---|---|---|---|---|---|---|
| D13 | A1 | 0 | 297 | 0.238 | 0.9476 | 90 | 270 | 3.00 |
| D14 | A1 | 0.01 | 255 | 0.250 | 0.9338 | 102 | 351 | 3.45 |
| D15 | A1 | 0.015 | 336 | 0.282 | 0.9256 | 88 | 289 | 3.27 |
| D16 | A3 | 0 | 479 | 0.274 | 0.9461 | 88 | 231 | 2.61 |
| D17 | A3 | 0.01 | 508 | 0.304 | 0.935 | 79 | 215 | 2.71 |
| D18 | A3 | 0.015 | 476 | 0.303 | 0.9283 | 73 | 204 | 2.79 |
| D19 | A4 | 0 | 491 | 0.314 | 0.9471 | 84 | 237 | 2.84 |
| D20 | A4 | 0.01 | 535 | 0.341 | 0.9338 | 77 | 223 | 2.91 |
| D21 | A4 | 0.015 | 554 | 0.315 | 0.9261 | 78 | 230 | 2.94 |
| D22 | B1 | 0 | 316 | 0.297 | 0.9494 | 81 | 243 | 2.99 |
| D23 | B1 | 0.01 | 294 | 0.318 | 0.9345 | 104 | 338 | 3.25 |
| D24 | B1 | 0.015 | 427 | 0.353 | 0.9254 | 83 | 273 | 3.29 |
| D25* | B3 | 0 | 612 | 0.332 | 0.9432 | 92 | 268 | 2.93 |
| D26* | B3 | 0.01 | 577 | 0.351 | 0.9343 | 81 | 240 | 2.97 |
| D27* | B3 | 0.015 | 715 | 0.360 | 0.9279 | 78 | 221 | 2.83 |
| D28* | B4 | 0 | 998 | 0.356 | 0.9447 | 76 | 224 | 2.95 |
| D29* | B4 | 0.01 | 941 | 0.379 | 0.9348 | 71 | 216 | 3.05 |
| D30* | B4 | 0.015 | 951 | 0.375 | 0.9277 | 64 | 197 | 3.10 |
| D31 | C1 | 0 | 329 | 0.324 | 0.9496 | 75 | 221 | 2.94 |
| D32 | C1 | 0.01 | 369 | 0.361 | 0.9420 | 86 | 325 | 3.78 |
| D33 | C1 | 0.015 | 451 | 0.388 | 0.9253 | 75 | 258 | 3.43 |
| D34* | C3 | 0 | 486 | 0.268 | 0.9471 | 106 | 330 | 3.12 |
| D35* | C3 | 0.01 | 540 | 0.288 | 0.9446 | 75 | 324 | 4.32 |
| D36* | C3 | 0.015 | 595 | 0.347 | 0.9288 | 96 | 335 | 3.50 |
| D37* | C4 | 0 | 921 | 0.333 | 0.9469 | 76 | 250 | 3.27 |
| D38* | C4 | 0.01 | 1017 | 0.386 | 0.9339 | 70 | 247 | 3.54 |
| D39* | C4 | 0.015 | 1078 | 0.419 | 0.9274 | 67 | 220 | 3.30 |

Wherein the concepts in this table are as defined in the section relating to the homopolymerisation experiments, except that:
C6/C2 is the molar ratio of 1-hexene to ethylene in the reactor feed; and
Density is the density of the polyethylene product, as determined in accordance with ASTM D1505-18.
   *In the experiments D25-D30 and D34-D39, the quantity of catalyst system that was supplied was 40 mg, to prevent lump formation in the reactor and reactor overheating, caused by the high catalyst productivity.

1. Catalyst system for polymerisation of ethylene comprising a porous support material, wherein the support material comprises:
(i) a quantity of a compound (a) of formula (I) 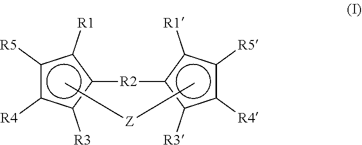
wherein:
Z is a moiety selected from M-X2, wherein X is selected from the group of halogens, alkyls, aryls and aralkyls and wherein M is selected from Zr, Hf and Ti;
R2 is a silane bridging moiety;
each R1, R1′, R3, R3′, R4, R4′, R5 and R5′ are hydrogen or a hydrocarbon moiety comprising 1-20 carbon atoms; and
(ii) a quantity of methylaluminoxane;
wherein the catalyst system comprises:
≥2.5*10⁻⁵ mol/g of M, with regard to the total weight of the catalyst system, and
≥5.0 wt % of aluminium, with regard to the total weight of the catalyst system.

2. Catalyst system according to claim 1, wherein the silane bridging moiety is a moiety of formula: 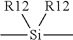
wherein each moiety R12 is a is a hydrocarbyl group.

3. Catalyst system according to claim 2, wherein each R12 is a moiety selected from methyl, ethyl, n-propyl, isopropyl, n-butyl, or isobutyl.

4. Catalyst system according to claim 1, wherein the silane bridging moiety is a dimethylsilane moiety.

5. Catalyst system according to claim 1, wherein the catalyst system comprises a quantity of a complex (b) obtained by reacting a quantity of an aluminium compound of formula (II) with a quantity of an amine compound of formula (III) in a hydrocarbon solvent; 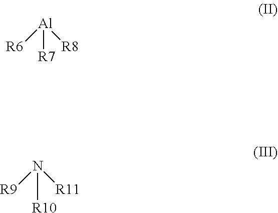
wherein R6 is hydrogen or a hydrocarbon moiety comprising 1 to 30 carbon atoms; each R7 and R8 are the same or different and are hydrocarbon moieties comprising 1 to 30 carbon atoms; R9 is hydrogen or a functional moiety comprising at least one active hydrogen; R10 is hydrogen or a hydrocarbon moiety comprising 1 to 30 carbon atoms; R11 is a hydrocarbon moiety comprising 1 to 30 carbon atoms.

6. Catalyst system according to claim 5, wherein the complex (b) is a triisobutylaluminium/cyclohexylamine complex.

7. Catalyst system according to claim 1, wherein the porous support material is selected from a cross-linked or functionalised polystyrene, a polyvinylchloride, a cross-linked polyethylene, a silica, an MgCl2, a talc, and a zeolite.

8. Catalyst system according to claim 1, wherein
the molar ratio of the methylaluminoxane to the compound (a) is ≥50 and ≤500; and/or
the weight ratio of the methylaluminoxane to the support material is ≥0.1 and ≤ 0.8; and/or
the weight ratio of the compound (a) to the support material is ≥0.005 and ≤0.08.

9. Catalyst system according to claim 1, wherein the porous support material comprises ≤0.1 wt % of aluminium with regard to the weight of the porous support material.

10. Catalyst system according to claim 1, wherein the compound (a) is selected from:
dichloro[[(1,2,3,3a, 7a-η)-2-(1-methylethyl)-1H-inden-1-ylidene](dimethylsilylene)[(1,2,3,4,5-η)-2,3,4,5-tetramethyl-2,4-cyclopentadien-1-ylidene]]-zirconium;
dichloro[[(1,2,3,3a, 7a-η)-2-phenyl-1H-inden-1-ylidene](dimethylsilylene)[(1,2,3,4,5-η)-2,3,4,5-tetramethyl-2,4-cyclopentadien-1-ylidene]]-zirconium;
dichloro[[(1,2,3,3a,7a-η)-2-methyl-4-phenyl-1H-inden-1-ylidene](dimethylsilylene)[(1,2,3,4,5-η)-2,3,4,5-tetramethyl-2,4-cyclopentadien-1-ylidene]]-zirconium;
dichloro[[(1,2,3,3a,7a-η)-3-phenyl-1H-inden-1-ylidene](dimethylsilylene)[(1,2,3,4,5-η)-2,3,4,5-tetramethyl-2,4-cyclopentadien-1-ylidene]]-zirconium;
dichloro[[(1,2,3,3a,7a-η)-2-phenyl-3-methyl-1H-inden-1-ylidene](dimethylsilylene)[(1,2,3,4,5-η)-2,3,4,5-tetramethyl-2,4-cyclopentadien-1-ylidene]]-zirconium;
dichloro[[(1,2,3,3a, 7a-η)-2-phenyl-1H-inden-1-ylidene](dimethylsilylene)[(1,2,3,3a,7a-η)-1H-inden-2-ylidene]]-zirconium;
dichloro[[(1,2,3,3a,7a-η)-2-(3,5-dimethylphenyl)-1H-inden-1-ylidene](dimethylsilylene)[(1,2,3,3a,7a-η)-1,3-dimethyl-1H-inden-2-ylidene]]-zirconium;
dichloro[[(1,2,3,3a, 7a-η)-2-tertiarybutyl-1H-inden-1-ylidene](dimethylsilylene)[(1,2,3,3a,7a-η)-1,3-dimethyl-1H-inden-2-ylidene]]-zirconium;
dichloro[[(1,2,3,3a,7a-η)-1H-inden-2-ylidene](dimethylsilylene)[(1,2,3,4,5-η)-2,3,4,5-tetramethyl-2,4-cyclopentadien-1-ylidene]]-zirconium;
dichloro[[(1,2,3,3a,7a-η)-2-(1-methylethyl)-1H-inden-1-ylidene](dimethylsilylene)[(1,2,3,3a,7a-η)-1,3-dimethyl-1H-inden-2-ylidene]]-zirconium;
dichloro[[(1,2,3,3a,7a-η)-2-phenyl-3-methyl-1H-inden-1-ylidene](dimethylsilylene)[(1,2,3,3a,7a-η)-1,3-dimethyl-1H-inden-2-ylidene]]-zirconium;
[[(1,2,3,3a, 7a-η)-2-(1-methylethyl)-1H-inden-1-ylidene](dimethylsilylene)[(1,2,3,4,5-η)-2,3,4,5-tetramethyl-2,4-cyclopentadien-1-ylidene]]-hafnium; and
dichloro[[(1,2,3,3a,7a-η)-2-phenyl-1H-inden-1-ylidene](dimethylsilylene)[(1,2,3,4,5-η)-2,3,4,5-tetramethyl-2,4-cyclopentadien-1-ylidene]]-hafnium.

11. Catalyst system according to claim 1, wherein the moieties R4 and R5 are fused to form a cyclic structure, and/or wherein the moieties R4′ and R5′ are fused to form a cyclic structure, and/or wherein the moieties R3′ and R4′ are fused to form a cyclic structure, and/or wherein the moieties R3 and R4 are fused to form a cyclic structure.

12. Process for preparation of a catalyst system according to claim 1, wherein the process involves the steps in this order of:
(i) preparing a first mixture by subjecting a quantity of compound (a) together with a quantity of the methylaluminoxane as solution in a hydrocarbon solvent;
(ii) preparing a second mixture by reacting a quantity of triisobutylaluminium with a quantity of cyclohexylamine in a hydrocarbon solvent;
(iii) providing a quantity of the support material into a reaction vessel;
(iv) providing a quantity of a hydrocarbon solvent into the reaction vessel;
(v) supplying the first mixture and the second mixture to the reaction vessel;
(vi) subjecting the contents of the reaction vessel to a temperature of >60° C. for a period of >3 hrs to obtain a catalyst system; and
(vii) removing the hydrocarbon solvent from the catalyst system.

13. Process according to claim 12, wherein the temperature in step (vi) is >90° C.

14. Process for polymerisation of ethylene, wherein the polymerisation is performed in the presence of a catalyst system according to claim 1.

15. Polyethylene composition comprising the catalyst system according to claim 1.
